(19) United States
(12) Patent Application Publication
(10) Pub. No.: US 2014/0256530 A1
(43) Pub. Date: Sep. 11, 2014

(54) GLASS-CERAMIC AS DIELECTRIC IN THE HIGH-FREQUENCY RANGE

(71) Applicant: Schott AG, Mainz (DE)

(72) Inventors: Hubertus BRAUN, Sprendlingen (DE); Martin LETZ, Mainz (DE); Bernd RUEDINGER, Woerrstadt (DE); Daniela SEILER, Alzey (DE)

(73) Assignee: Schott AG, Mainz (DE)

(21) Appl. No.: 14/283,715

(22) Filed: May 21, 2014

Related U.S. Application Data
(63) Continuation of application No. PCT/EP2012/073174, filed on Nov. 21, 2012.

(30) Foreign Application Priority Data
Nov. 24, 2011 (DE) 10 2011 119 804.4

(51) Int. Cl. C03C 10/00

(52) U.S. Cl. CPC C03C 10/0036
USPC 501/32; 65/33.7

(57) ABSTRACT

A glass-ceramic is disclosed which can be used in particular as a dielectric and which has at least the following constituents (in mol % on oxide basis): SiO₂ 1-50, Al₂O₃ 0-20, B₂O₃ 0-25, TiO₂ 10-70, RE₂O₃ 0-35, wherein RE is lanthanum, another lanthanoid, or yttrium, wherein Ti may be replaced in part, preferably up to 10%, by Zr, Hf, Y, Nb, V, Ta, and wherein the porosity is less than 0.5%.

### CROSS REFERENCES TO RELATED APPLICATIONS

This application is a continuation of international patent application PCT/EP2012/073174, filed on Nov. 21, 2012 designating the U.S., which international patent application has been published in German language and claims priority from German patent application 10 2011 119 804.4, filed on Nov. 24, 2011. The entire of both of these priority applications are incorporated herein by reference.

### BACKGROUND OF THE INVENTION

The invention relates to a glass-ceramic which can be employed as a dielectric in the high-frequency range (frequency >200 MHz), more particularly in the gigahertz range (frequency f>1 GHz).

A series of applications in the high-frequency range require specific materials having an extremely high relative permittivity ε in conjunction with an extremely low dielectric loss (tan δ). In order to avoid close-range detuning due to the body of a user (referred to as “body loading”), dielectric charging is particularly significant in connection with antennas, filters, and other devices. Required for this purpose are dielectrics which have a high relative permittivity, with ε≧15, and also a low dielectric loss (tan δ) of not more than 10⁻², preferably lower, in the high-frequency range. Furthermore, the temperature dependence of the resonance frequency ε_{f} is to be extremely low. Lastly, a material of this kind is to be able to be processed in an extremely simple and inexpensive way in order to allow near-net shaping at favorable cost.

A series of ceramic materials processed by sintering operations are known in the prior art. A first glass-ceramic system, obtained by way of a glass melt, is a BiNbO₄ system, disclosed in Mirsaneh et al., “Circularly Loaded Dielectric-Loaded Antennas: Current Technology and Future Challanges”, Adv. Funct. Materials 18, (2008), pp. 1-8, for application with dielectrically charged antennas for the gigahertz range. This material is utilized for producing the two principally utilized forms of antennas, the circularly polarized DLA helix antenna (D-LQH antenna) and the square patch antenna. For this purpose, a glass having the composition 30 mol % of Bi₂O₃, 30 mol % of Nb₂O₅, 30 mol % of B₂O₃, and 10 mol % of SiO₂ is melted in a conventional way at 1250° C. for two hours.

This glass was poured into cylindrical molds, relaxed at 500 to 520° C., and cooled slowly to room temperature. This was followed by crystallization at various temperatures between 600° C. and 1000° C. The optimum value for antenna applications is said to be, for a heat treatment at 960° C., a relative permittivitiy ε of 15 with a quality factor Q·f₀ of 15 000 GHz and a temperature coefficient of the resonance frequency τ_{f} of −80 MK⁻¹. The crystalline phase characterized in this case was substantially orthorhombic BiNbO₄.

This system, using bismuth and niobium, is very expensive in terms of the raw materials.

In addition there is a series of sintered ceramic materials (cf. U.S. Pat. No. 6,184,845 B1, US 2007/063902 A1). Specified therein as dielectric material for the ceramic core of a dielectrically charged D-LQH antenna is a sintered ceramic material based on zirconium titanate and, respectively, based on zirconium tin titanate, having a relative permittivity of about 36. The material is said to be produced by extrusion or pressing and subsequent sintering.

Further sintered materials are disclosed in the review by M. T. Sebastian et al., “Low loss dielectric materials for LTCC applications”, International Materials Reviews, vol. 53, 2008, pp. 57-90. Although some of these materials are referred to as “glass-ceramics”, they are in fact sintered materials, being produced by the sintering of a mixture of vitreous and crystalline powders.

US 2002/0037804 A1 and US 2004/0009863 A1 further disclose dielectric ceramics which are said to form diverse crystal phases, such as, for instance, CaTiO₃, SrTiO₃, Ba Ti₄O₉, La₂Ti₂O₇, Nd₂Ti₂O, Ba₂Ti₉O₂₀, Mg₂TiO₄, Mg₂SiO₄, Zn₂TiO₄, etc., which are said to be responsible for high quality factors. These again are sintered ceramics.

Dielectrics produced by sintering have a series of disadvantages: Every sintering operation always entails a certain shrinkage, leading to geometric inaccuracies and corresponding final machining. Furthermore, every sintering operation results in a certain residual porosity, which is a disadvantage if the surface is metalized. The metal penetrates the pores and raises the dielectric loss of the dielectric.

Moreover, the production of sintered materials is fundamentally relatively inconvenient and expensive.

JP 2006124201 A discloses, additionally, a lead-free glass which is said to be used for producing a dielectric for a printed circuit, having a high dielectric constant and a low electrical loss. The glass comprises (in mol %): 25 to 45 SiO₂, 5 to 25 BaO, 18 to 35 TiO₂, 1 to 10 Al₂O₃, 0 to 15 B₂O₃, 0 to 15 MgO+CaO+SrO, 0 to 7 WO+ZrO₂, with ZnO<1. It is said to crystallize on heat treatment as BaTi₄O₉.

JP 2011-195440 A, which corresponds in terms of content to German patent application DE 10 2010 012 524.5, discloses, additionally, a glass-ceramic comprising the following constituents (in mol % on oxide basis):

| | |
|---|---|
| SiO₂ | 5-50 |
| Al₂O₃ | 0-20 |
| B₂O₃ | 0-25 |
| BaO | 0-25 |
| TiO₂ | 10-60 |
| RE₂O₃ | 5-35 |

wherein Ba may be replaced in part by Sr, Ca, Mg, wherein RE is lanthanum, another lanthanoid, or yttrium, and wherein Ti may be replaced in part by Zr, Hf, Y, Nb, V, Ta.

This glass-ceramic can be used to produce high-quality dielectrics which are suitable in particular for high-frequency applications, such as antennas. A disadvantage which has become apparent here, however, is that even this glass-ceramic is not optimized for the production of antennas, necessitating a subsequent metallization of the surface. The residual porosity is still relatively high for this. Moreover, this glass-ceramic is not optimized in terms of minimum temperature dependence of the resonance frequency, which represents an important criterion for antenna applications.

### SUMMARY OF THE INVENTION

In view of this, it is a first object of the invention to disclose an improved material which can be employed as a dielectric for high-frequency applications.

It is a second object of the invention to disclose a dielectric material for high-frequency applications which has a high relative permittivity and a low dielectric loss.

It is a third object of the invention to disclose a dielectric material for high-frequency applications which can be produced and processed in a simple and inexpensive way.

It is a forth object of the invention to disclose a dielectric material which is particularly suited for the production of antennas, and more particularly, for the production of GPS antennas.

It is a fifth object of the invention to disclose a dielectric material having a resonance frequency with a small temperature dependence.

According to one aspect of the invention these and other objects are solved by a glass-ceramic comprising at least the following constituents (in mol % on oxide basis):

| | |
|---|---|
| SiO₂ | 1-50 |
| Al₂O₃ | 0-20 |
| B₂O₃ | 0-25 |
| TiO₂ | 10-70 |
| RE₂O₃ | 0-35 |
| BaO | 0-35 |

wherein RE is selected from the group consisting of a lanthanoid and yttrium, and wherein Ti may be replaced at least partially, by at least one constituent selected from the group consisting of Zr, Hf, Y, Nb, V, and Ta, and wherein a porosity of said glass-ceramic is smaller than 0.5%.

It has emerged that with a glass-ceramic of this kind it is possible to produce particularly high-quality antennas, since particularly low losses occur during metallization, on account of the very low porosity. The porosities obtained using the glass-ceramics produced by melting are very low, being preferably <0.1%, more particularly <0.01%.

In further embodiment of the invention, the glass-ceramic comprises at least the following constituents (in mol % on oxide basis):

| | |
|---|---|
| SiO₂ | 10-35 |
| Al₂O₃ | 0-20 |
| B₂O₃ | ≦10 |
| TiO₂ | 25-60 |
| RE₂O₃ | 10-30, |
| SiO₂ + Al₂O₃ + B₂O₃ | <45 |

wherein RE is lanthanum, another lanthanoid, or yttrium, and wherein Ti may be replaced in part, preferably up to 10% of the obligatory content, by Zr, Hf, Y, Nb, V, Ta.

In alternative embodiment of the invention, the glass-ceramic comprises at least the following constituents (in mol % on oxide basis):

| | |
|---|---|
| SiO₂ | 10-30 |
| Al₂O₃ | 0-20 |
| B₂O₃ | 0-25 |
| TiO₂ | 35-70 |
| RE₂O₃ | 10-30 |
| BaO | 0-35 |

where RE is lanthanum, another lanthanoid, or yttrium, and where Ti may be replaced in part, preferably up to 10%, by Zr, Hf, Y, Nb, V, Ta, and where the porosity is <0.5%.

The glass-ceramic in this context may comprise, in particular, 15 to 30 mol % of La₂O₃ and/or 15 to 30 mol % of Nd₂O₃.

In preferred development of the invention, the fraction of B₂O₃ is <9 mol %.

In the case of a higher concentration of B₂O₃, the LaBO₃ crystal phase is formed. This, owing to the very low dielectric constant E of only 12.5, results in a lowering in the overall dielectric constant and in an increased incidence of scattering, which effectively lowers the quality of the material.

In further-preferred embodiment of the invention, the TiO₂ content is greater than 41 mol %.

In further-preferred embodiment of the invention, the glass-ceramic comprises 0.01 up to 3 mol % of at least one refining agent selected preferably from the group consisting of As₂O₃ and Sb₂O₃.

It has emerged that even very low concentrations particularly of Sb₂O₃ positively influence the quality of the glass-ceramic.

The glass-ceramic preferably has a dielectric loss (tan δ) of not more than 10⁻², preferably of not more than 10⁻³, in the high-frequency range (frequency f>200 MHz).

The relative permittivity ε is at least 15, preferably >18, and is preferably in the range from 20 to 80.

Furthermore, a very low temperature dependence of the resonance frequency can be achieved. Under optimized ceramizing conditions in particular, the absolute value of the temperature dependence of the resonance frequency |τf| may be limited to not more than 200 ppm/K, preferably not more than 50 ppm/K, very preferably not more than 10 ppm/K.

The glass-ceramic of the invention comprises at least one solid-solution phase based on RE, Ti, Si, O, and optionally Ba, where Ba may be replaced at least in part by Sr, Ca, Mg, where RE is a lanthanoid or yttrium, and where Ti may be replaced at least in part by Zr, Hf, Y, Nb, V, Ta.

The glass ceramic comprises preferably at least one solid-solution phase selected from the group formed by (BaO)ₓ(RE₂O₃)_{y}(SiO₂)_{z}(TiO₂)ᵤ, e.g., RE₂Ti₂O₇, RE₂Ti₂SiO₉, and RE₄Ti₉O₂₄, where RE is lanthanum, another lanthanoid, or yttrium, where up to 10% of Ba may be replaced by Sr, Ca, Mg, and where up to 10% of Ti may be replaced by Zr, Hf, Y, Nb, V, Ta.

The crystalline fraction is preferably at least 30 vol %, preferably up to 95 vol %.

The average crystallite size is preferably 10 nanometers to 50 micrometers, preferably 100 nanometers to 1 micrometer.

The glass-ceramic of the invention can be used with preference as a dielectric resonator, as an electronic frequency filter element or antenna element for the high-frequency range.

This may be, for instance, a cylindrical antenna element or a patch antenna element.

The problem addressed by the invention is further solved by a dielectric having a dielectric loss of not more than 10⁻² in the high-frequency range, and produced by the following steps:

melting a starting glass which comprises the constituents (in mol % on oxide basis):

| | |
|---|---|
| SiO₂ | 1-50 |
| Al₂O₃ | 0-20 |
| B₂O₃ | 0-25 |
| TiO₂ | 10-70 |
| RE₂O₃ | 0-35 |
| BaO | 0-35 |

wherein RE is lanthanum, another lanthanoid, or yttrium, and wherein Ti may be replaced in part, preferably up to 10% of its obligatory content, by Zr, Hf, Y, Nb, V, Ta;
homogenizing such that the porosity is <0.5%, preferably <0.1%, more preferably <0.05%;
pouring the starting glass into a desired shape;
cooling the starting glass to room temperature;
ceramizing the starting glass by a heat treatment.

In this context, the absolute value of the temperature dependence of the resonance frequency |τ_{f}| is preferably not more than 200 ppm/K, preferably not more than 100 ppm/K, more preferably not more than 60 ppm/K, more preferably not more than 20 ppm/K, very preferably not more than 10 ppm/K.

This is achieved by a particular ceramizing treatment of the starting glass used. It has been found that by virtue of the contradictory properties of the residual glass and of the crystal fractions in the glass-ceramic it is possible, on optimized conduct of the ceramizing treatment, to bring about a temperature dependence of the resonance frequency of close to zero.

Ceramizing takes place preferably by heating to a target temperature of 900° C. to 1050° C., more particularly of 900° C. to 1000° C., more particularly of 930° C. to 1000° C., more particularly of 930° C. to 980° C., and subsequent holding over a duration of 1 to at least 3 hours, more particularly of 1 to 10 hours, more particularly of 3 to at least 5 hours, up to a maximum of about 25 hours, and also subsequent cooling to room temperature.

In the context of its production by a melting process, the starting glass can be brought into a near net shape. In that case either no post-treatment at all, or at most a slight post-treatment on its surface, by grinding, for instance, is required.

### BRIEF DESCRIPTION OF THE DRAWINGS

Further features and advantages of the invention will become apparent from the description hereinafter of preferred working examples, with reference to the drawing. In the drawing:

FIG. 1 shows an electron micrograph (EDX) of a comparative sample in the form of a (Ca, Mg)TiO₃— ceramic produced by sintering;

FIG. 2 shows an electron micrograph (EDX) of a sample in accordance with example 1 from Tab. 1.

### EXAMPLES

In Tab. 1 there is a combination of various glass compositions for a starting glass in the La—Ti—Si—O system, in some cases with additions of B and with refining agent (Sb). Further examples are included in Tab. 2.

TABLE 1

| | Composition (mol %) | | | | | | | |
|---|---|---|---|---|---|---|---|---|
| Example | 1 | 2 | 3 | 4 | 5 | 6 | 7 | 8 |
| SiO₂ | 28.17 | 26.29 | 27.93 | 20.75 | 21.13 | 21.02 | 18.42 | 27.97 |
| Al₂O₃ | 0.00 | 0.00 | 0.00 | 0.00 | 0.00 | 6.01 | 0.00 | 13.98 |
| B₂O₃ | 7.05 | 6.57 | 3.96 | 7.92 | 8.07 | 12.61 | 7.03 | 0.00 |
| TiO₂ | 43.12 | 44.69 | 45.39 | 49.88 | 47.16 | 40.24 | 56.76 | 38.64 |
| Sb₂O₃ | 0.10 | 0.10 | 0.10 | 0.10 | 0.10 | 0.00 | 0.06 | 0.10 |
| La₂O₃ | 21.56 | 22.34 | 22.70 | 21.38 | 23.58 | 20.12 | 17.74 | 19.32 |
| f/GHz | 9.95 | 9.83 | 9.94 | 9.99 | 11.06 | 10.65 | 9.97 | 10.46 |
| Q | 41 | 39 | 43 | 50 | 124 | 179 | 89 | 89 |
| Qf/GHz | 420 | 390 | 430 | 510 | 1450 | 2050 | 930 | 970 |
| ε | 23.9 | 23.5 | 23.6 | 23.2 | 18.8 | 21.0 | 23.4 | 21.2 |
| tan δ | 0.0239 | 0.0253 | 0.0230 | 0.0195 | 0.0076 | 0.0052 | 0.0108 | 0.0108 |

TABLE 2

| | Composition (mol %) | | | | | | | | |
|---|---|---|---|---|---|---|---|---|---|
| Example | 9 | 10 | 11 | 12 | 13 | 14 | 15 | 16 | 17 |
| SiO₂ | 21.0 | 28.17 | 22.34 | 20.77 | 20.0 | 20.0 | 19.0 | 17.5 | 17 |
| Nd₂O₃ | | | | | 20.0 | 22.0 | 21.5 | 21.14 | 22.45 |
| B₂O₃ | 12.60 | 7.05 | 6.57 | 6.66 | 6.0 | 6.0 | 7.0 | 8.0 | 6.0 |
| TiO₂ | 40.20 | 43.12 | 44.69 | 49.92 | 52.0 | 50.5 | 52.0 | 51.36 | 50.55 |
| Nb₂O₅ | | | | | 0 | 0 | 0 | 0 | 4.0 |
| La₂O₃ | 20.1 | 21.56 | 22.56 | 28.7 | 2 | 0 | 0 | 0 | 0 |
| ZrO₂ | | | | | 0 | 1.5 | 0 | 0 | 0 |
| BaO | | | | | 0 | 0 | 0 | 2 | 0 |
| CeO₂ | | | | | 0 | 0 | 0.5 | 0 | 0 |
| Sb₂O₃ | 0.1 | 0.1 | 0.1 | 0.05 | | | | | |
| f/GHz | 10.89 | 10.73 | 10.17 | 9.01 | 8.424 | 8.249 | 7.771 | 8.166 | 8.88 |
| Q | 443 | 87 | 39 | 139 | 648 | 528 | 856 | 260 | 633 |
| Qf/GHz | 4820 | 930 | 400 | 1250 | 5459 | 4355 | 6652 | 2123 | 5621 |
| ε | 18.9 | 19.7 | 22.3 | 27.6 | 23.9 | 24.9 | 28.1 | 25.6 | 21.6 |
| tan δ | 0.0024 | 0.0116 | 0.0254 | 0.0072 | 0.0014 | 0.0018 | 0.0011 | 0.0036 | 0.0014 |

Further examples are included in Tab. 2.

The various glass samples of examples 1 to 17 are first melted and homogenized in a conventional way, using customary starting materials; platinum crucibles, PT/RI crucibles, PT/RH crucibles, fused silica crucibles, or aluminum oxide crucibles may be used. The samples are first melted at 1350° C. for 2 hours, then refined at 1400° C. for 30 minutes, stirred and homogenized for 20 minutes by means of a platinum stirrer, left to stand for 10 minutes, and then poured into suitable molds made of steel, graphite, aluminum oxide, or fused silica, for instance, and thus brought into a near net shape.

After cooling to room temperature, the glass is subjected to a ceramizing step, which is accomplished preferably by means of an infrared heating process.

A typical ceramizing cycle with the aid of an infrared furnace is as follows:
heating at 300 K/min to 1050° C.;
holding at 1050° C. for 7 seconds;
heating to 1200° C. at a heating rate of 50 K/min;
holding at 1200° C. for 15 minutes;
cooling to about 500° C. by switching off the furnace, with a cooling rate of about 50 K/min;
removal of the sample from the furnace when the temperature has reached about 500° C.

An alternative possibility would be to carry out a ceramizing cycle in a conventional oven, by heat treatment at 925° C. over 15 hours. In addition, a series of ceramizing cycles were systematically investigated. The results are summarized in Tab. 3.

The starting glass used in this case was a glass with the following composition (in mol % on oxide basis) (example 18):

| | |
|---|---|
| SiO₂ | 21.0 |
| Al₂O₃ | 6.0 |
| B₂O₃ | 12.6 |
| TiO₂ | 40.2 |
| La₂O₃ | 20.1 |
| Sb₂O₃ | 0.1. |

TABLE 3

| Sample | T_{K}[° C.] | t_{H}[h] | GPA | La₄ | La₂ | TiO₂ | fᵣₑₛ | εᵣ | Qf | tan(δ) | τ_{f} |
|---|---|---|---|---|---|---|---|---|---|---|---|
| 10 | Glass | — | 100 | 0 | 0 | 0 | 11.31 | 17.5 | 1850 | 6.06 | −82.8 |
| 11 | 880 | 5 | 97.0 | 2.7 | 0.3 | 0 | 11.52 | 17.6 | 2220 | 5.18 | −51.3 |
| 12 | 890 | 5 | 90.4 | 7.9 | 1.7 | 0 | 11.24 | 17.8 | 3600 | 3.12 | −18.8 |
| 13 | 895 | 5 | 85.6 | 12.3 | 2.1 | 0 | 11.47 | 17.6 | 2470 | 4.64 | |
| 14 | 900 | 5 | 70.3 | 26.0 | 3.7 | 0 | 11.38 | 18.0 | 3780 | 3.01 | −13.3 |
| 15 | 905 | 5 | 80.4 | 17.2 | 2.4 | 0 | 11.36 | 18.0 | 3940 | 2.88 | |
| 16 | 910 | 1. | 88.8 | 9.3 | 1.9 | 0 | 11.37 | 18.1 | 3220 | 3.53 | |
| 17 | 910 | 3 | 79.4 | 17.0 | 3.6 | 0 | 11.34 | 18.1 | 3200 | 3.54 | |
| 18 | 910 | 5 | 67.6 | 26.3 | 6.1 | 0 | 11.41 | 18.0 | 4800 | 2.38 | −9.5 |
| 19 | 930 | 5 | 74.4 | 18.2 | 6.9 | 0.5 | 11.12 | 18.9 | 4640 | 2.40 | −3.0 |
| 20 | 950 | 5 | 71.2 | 15.7 | 11.2 | 1.9 | 10.89 | 18.9 | 4820 | 2.26 | +7.6 |
| 21 | 1000 | 5 | 62.0 | 0 | 33.6 | 4.4 | 10.46 | 21.3 | 4400 | 2.38 | +57.7 |
| 22 | 1050 | 5 | 67.8 | 0 | 28.4 | 3.8 | 10.40 | 21.5 | 4670 | 2.39 | |
| 23 | 1100 | 5 | 66.0 | 0 | 29.6 | 4.4 | 9.98 | 22.5 | 4600 | 2.17 | +51.1 |

In Tab. 3 there are summarized results of the ceramizing series in the conventional oven, with T_{K} being the ceramizing temperature [° C.], with the ceramizing duration t_{H} [hours], with GPA (glass phase fraction by X-ray diffraction, Rietveld analysis), with the absolute phase fraction in wt %, and with the data for the measuring frequency fᵣₑₛ [GHz], the dielectric constant εᵣ, the quality factor Q_{f} [GHz], tan δ [10⁻³], and τ_{f} [ppm/K] according to Hakki-Coleman.

It is found that by optimizing the ceramizing parameters it is possible to boost the quality factor significantly in conjunction with a low tan δ and with an absolutely low τ_{f} in the vicinity of 0.

Where necessary, the moldings, after having been produced by pouring, can be finished by a grinding or polishing treatment or, in the case of the production of cylindrical moldings, can be machined by centerless grinding of the cylindrical surface.

The volume fraction of the crystalline phase in the case of examples 1 to 7 as per Tab. 1 is in the order of magnitude of about 50 to 70 vol %.

Relative permittivities ε measured on samples 1 to 7 were all greater than 15 and were within the range from 20 to 50.

The samples additionally feature a low dielectric loss and a high quality.

The quality Q is the reciprocal of the dielectric loss (tan δ):

Q=1/tan(δ).

The quality is measured by the resonance method according to Hakki-Coleman. With this method, the quality factor is ascertained as the product of quality Q and measuring frequency f0.

Apart from example 1, all examples have a quality factor Q·f₀ in the range of more than 1000 GHz. For example 5, a quality factor Q of 418 was measured at 7.547 GHz, giving a quality factor of 3155 GHz.

The temperature coefficient τ_{f} of the resonance frequency is very low for all of the samples measured.

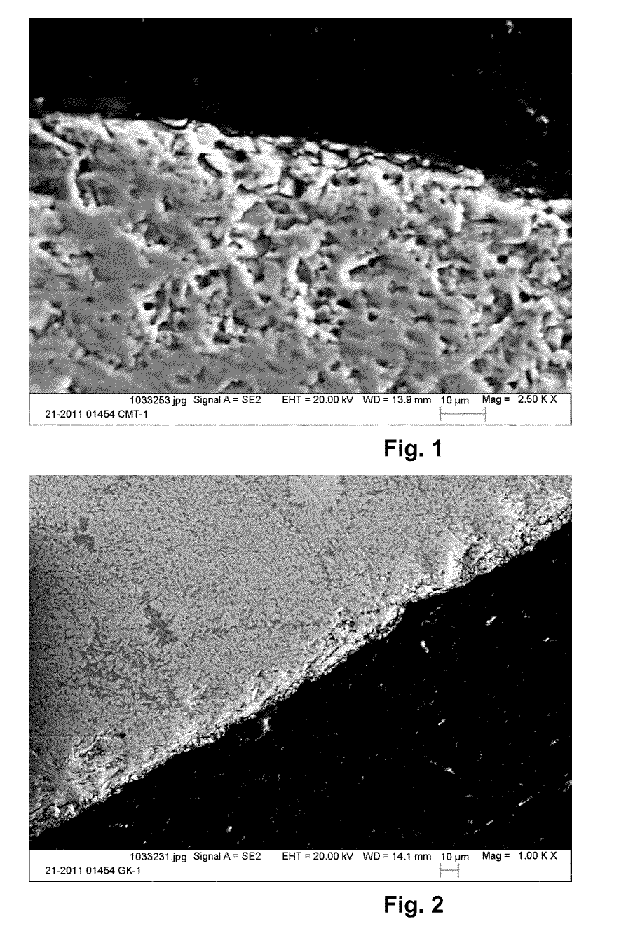

FIGS. 1 and 2 show electron micrographs (EDX) of a conventional comparative sample in the form of a (Ca, Mg)TiO₃— ceramic, produced by sintering, and of a sample according to the invention, composed of a glass-ceramic as per example 1 from Tab. 1. Both micrographs were made along a sectioned edge. Whereas in the case of FIG. 1 (conventional sintered ceramic) a porosity is clearly apparent, the glass-ceramic of the invention, according to FIG. 2, is largely pore-free. Only at the surface are there small pores visible, originating from the polishing operation. The structure of the crystallites is clearly visible against the dark background of the residual glass phase.

In the case of dielectric applications for antennas suitable more particularly as mobile GPS antennas for cell phones, the frequency range is above 200 MHz, more particularly in the range from about 800 MHz to 70 GHz. The dielectric charging of the antenna reduces the sensitivity of the antenna to detuning by the user.

Cylindrical antenna elements were produced from samples of examples 1 to 8 as per Tab. 1, and their surfaces were coated in the desired structure with copper by means of a lithographic technique. Comparative measurements with conventional antenna elements of the same size and same construction made from the sintered ceramic CMT (calcium magnesium titanate) showed in spite of significantly lower quality (Q=2050 at 10.6 GHz, with permittivity ε=21.2) in comparison to Q=56 000 at 7.0 GHz with similar permittivity, that there was a comparable efficiency (gain) for both antennas. The glass-ceramic antennas with a composition (according to example 18) had about 71% of the efficiency of the CMT antenna elements.

Taking account of the fact that with optimized compositions and ceramizing cycles it is also possible with the glass-ceramics to achieve significantly better quality values of 4000 or more (cf. Tab. 3), it is found that the antennas producible using the glass-ceramics of the invention are comparable to or better than those produced using conventional sintered ceramic (CMT).

It is thought that this good performance is attributable to the very low porosity of the glass-ceramic, which prevents disadvantageous effects of microporosity at the surface in the case of metallization as for the sintered ceramic.

1. A glass-ceramic comprising at least the following constituents (in mol % on oxide basis):

| | |
|---|---|
| SiO₂ | 1-50 |
| Al₂O₃ | 0-20 |
| B₂O₃ | 0-25 |
| TiO₂ | 10-70 |
| RE₂O₃ | 0-35 |
| BaO | 0-35 |

wherein RE is selected from the group consisting of a lanthanoid and yttrium; wherein Ti may be replaced at least partially by at least one constituent selected from the group consisting of Zr, Hf, Y, Nb, V, and Ta;
said glass-ceramic having a porosity <0.5%;
said glass-ceramic comprising at least one solid-solution phase selected from the group formed by (BaO)ₓ(RE₂O₃)_{y}(SiO₂)_{z}(TiO₂)ᵤ, wherein RE is selected from the group consisting of a lanthanoid and yttrium, wherein up to 10% of Ba may be replaced by at least one constituent selected from the group consisting of Sr, Ca, and Mg, and wherein up to 10% of Ti may be replaced by at least one constituent selected from the group consisting of Zr, Hf, Y, Nb, V, and Ta.

2. The glass-ceramic of claim 1, comprising at least the following constituents (in mol % on oxide basis):

| | |
|---|---|
| SiO₂ | 10-35 |
| Al₂O₃ | 0-20 |
| B₂O₃ | ≦10 |
| TiO₂ | 25-60 |
| RE₂O₃ | 10-30, |
| SiO₂ + Al₂O₃ + B₂O₃ | <45. |

3. A glass-ceramic comprising at least the following constituents (in mol % on oxide basis):

| | |
|---|---|
| SiO₂ | 10-30 |
| Al₂O₃ | 0-20 |
| B₂O₃ | 0-25 |
| TiO₂ | 35-70 |
| RE₂O₃ | 10-30 |
| BaO | 0-35 |

wherein RE is selected from the group consisting of a lanthanoid and yttrium, wherein Ti may be replaced at least partially, by at least one constituent selected from the group consisting of Zr, Hf, Y, Nb, V, and Ta, and wherein a porosity of said glass-ceramic is smaller than 0.5%.

4. The glass-ceramic of claim 3, comprising 15 to 30 mol % of La₂O₃.

5. The glass-ceramic of claim 3, comprising 15 to 30 mol % of Nd₂O₃.

6. The glass-ceramic of claim 3, comprising more than 41 mol % of TiO₂.

7. The glass-ceramic of claim 3, wherein the fraction of B₂O₃ is <9 mol %.

8. A glass-ceramic comprising at least the following constituents (in mol % on oxide basis):

| | |
|---|---|
| SiO₂ | 1-50 |
| Al₂O₃ | 0-20 |
| B₂O₃ | 0-25 |
| TiO₂ | 10-70 |
| RE₂O₃ | 0-35 |
| BaO | 0-35 |

wherein RE is selected from the group consisting of a lanthanoid and yttrium, and wherein Ti may be replaced at least partially, by at least one constituent selected from the group consisting of Zr, Hf, Y, Nb, V, and Ta, and wherein a porosity of said glass-ceramic is smaller than 0.5%.

9. The glass-ceramic of claim 8, comprising more than 41 mol % of TiO₂.

10. The glass-ceramic of claim 8, comprising 0.01 up to 3 mol % of at least one refining agent.

11. The glass-ceramic of claim 8, wherein said refining agent is selected from the group consisting of As₂O₃ and Sb₂O₃.

12. The glass-ceramic of claim 8, having a dielectric loss (tan δ) of not more than 10⁻² in a high-frequency range at frequency f>200 MHz.

13. The glass-ceramic of claim 8, having a relative permittivity ε of at least 15.

14. The glass-ceramic of claim 8, having a resonance frequency with a certain temperature dependence, an absolute value of said temperature dependence of said resonance frequency |τ_{f}| being at the most 200 ppm/K.

15. The glass-ceramic of claim 14, wherein said temperature dependence of said resonance frequency |τ_{f}| is not more than 10 ppm/K.

16. The glass-ceramic of claim 8, comprising at least one solid-solution phase based on RE, Ti, Si, and O, wherein RE is selected from the group consisting of a lanthanoid and yttrium, and wherein Ti may be replaced by at least one constituent selected from the group consisting of Zr, Hf, Y, Nb, V, and Ta.

17. The glass-ceramic of claim 16, wherein Ba is replaced at least in part by least least one constituent selected from the group consisting of Sr, Ca, and Mg.

18. The glass-ceramic of claim 8, comprising at least one solid-solution phase selected from the group formed by (BaO)ₓ(RE₂O₃)_{y}(SiO₂)_{z}(TiO₂)ᵤ, wherein RE is selected from the group consisting of a lanthanoid and yttrium, wherein up to 10% of Ba may be replaced by at least one constituent selected from the group consisting of Sr, Ca, and Mg, and wherein up to 10% of Ti may be replaced by at least one constituent selected from the group consisting of Zr, Hf, Y, Nb, V, and Ta.

19. A dielectric consisting of a glass-ceramic according to claim 8, produced by the following steps:
melting a starting glass comprising the following constituents (in mol % on oxide basis):

| | |
|---|---|
| SiO₂ | 1-50 |
| Al₂O₃ | 0-20 |
| B₂O₃ | 0-25 |
| TiO₂ | 10-70 |
| RE₂O₃ | 0-35 |
| BaO | 0-35 |

wherein RE is lanthanum, another lanthanoid, or yttrium, and wherein Ti may be replaced in part, preferably up to 10%, by Zr, Hf, Y, Nb, V, Ta;
homogenizing until a porosity <0.5% is obtained;
pouring said starting glass into a desired shape;
cooling said starting glass to room temperature;
ceramizing said starting glass by a heat treatment at a temperature and for a time so that an absolute amount of a temperature dependence of a resonance frequency |τ_{f}| is not more than 200 ppm/K.

20. The dielectric of claim 19, ceramized by a heat treatment in which heating takes place up to a target temperature of 900° C. to 1050° C., and is maintained over a duration of 1 to at least 3 hours, followed by cooling to room temperature.
